(19) United States
(12) Patent Application Publication
(10) Pub. No.: US 2025/0323788 A1
(43) Pub. Date: Oct. 16, 2025

(54) AUTHENTICATING AVATAR DATA DURING AUGMENTED REALITY (AR) COMMUNICATION SESSIONS

(71) Applicant: QUALCOMM Incorporated, San Diego, CA (US)

(72) Inventors: Imed Bouazizi, Celina, TX (US); Michel Adib Sarkis, San Diego, CA (US); Thomas Stockhammer, Bergen (DE)

(21) Appl. No.: 19/175,787

(22) Filed: Apr. 10, 2025

Related U.S. Application Data
(60) Provisional application No. 63/633,149, filed on Apr. 12, 2024.

(51) Int. Cl. H04L 9/32; G06T 13/40; G06V 40/16

(52) U.S. Cl. CPC H04L 9/321; G06T 13/40; G06V 40/168; G06V 40/172; H04L 9/3231

(57) ABSTRACT

An example device for exchanging augmented reality (AR) media data includes: a memory configured to store AR media data; and a processing system comprising one or more processors implemented in circuitry and configured to: receive video data representing distinguishing elements of a user associated with an avatar to be presented during an AR communication session; extract authentication features from the video data; use a public key of the user to verify authenticity of stored authentication features corresponding to the avatar; in response to verifying authenticity of the stored authentication features, compare the extracted authentication features to stored authentication features to authenticate use of the avatar by the user; and in response to authenticating use of the avatar by the user, present the avatar during the AR communication session.

This application claims the benefit of U.S. Provisional Application No. 63/633,149, filed Apr. 12, 2024, the entire contents of which are hereby incorporated by reference.

### TECHNICAL FIELD

This disclosure relates to transport of media data, such as augmented reality (AR) media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The media data may be assembled into a video file conforming to any of a variety of standards, such as the International Organization for Standardization (ISO) base media file format and extensions thereof, such as AVC.

### SUMMARY

In general, this disclosure describes techniques for protecting digital assets exchanged during an extended reality (XR) call. XR may generally represent, for example, augmented reality (AR), virtual reality (VR), or mixed reality (MR). Thus, unless otherwise noted, references to “XR call” or “XR communication session” may also be understood as an AR call, an MR call, a VR call, or the like. Participants in an XR call may have digital assets that they wish to protect, such as a digital avatar, an outfit for the digital avatar, items held by or used as decorations for the digital avatar, or the like. While the participants may wish to present these digital assets in a virtual scene for the XR call, the participants may wish to prevent others from stealing the digital assets. Theft of digital assets may infringe intellectual property or may be used by a malicious user to impersonate the user the digital assets were stolen from. The techniques of this disclosure may be used to protect digital assets used in an XR call from theft and/or unauthorized use.

In one example, a method of receiving augmented reality (AR) media data includes: receiving video data representing distinguishing elements of a user associated with an avatar to be presented during an AR communication session; extracting authentication features from the video data; using a public key of the user to verify authenticity of stored authentication features corresponding to the avatar; in response to verifying authenticity of the stored authentication features, comparing the extracted authentication features to stored authentication features to authenticate use of the avatar by the user; and in response to authenticating use of the avatar by the user, presenting the avatar during the AR communication session.

In another example, a method of sending augmented reality (AR) media data includes: encrypting authentication features representing distinguishing elements of a first user associated with an avatar to be presented during an AR communication session; sending the encrypted authentication features and the avatar to a second user; and sending one or more video streams of the distinguishing elements of the first user to the second user.

In another example, a device for exchanging augmented reality (AR) media data includes: a memory configured to store AR media data; and a processing system comprising one or more processors implemented in circuitry and configured to: receive video data representing distinguishing elements of a user associated with an avatar to be presented during an AR communication session; extract authentication features from the video data; use a public key of the user to verify authenticity of stored authentication features corresponding to the avatar; in response to verifying authenticity of the stored authentication features, compare the extracted authentication features to stored authentication features to authenticate use of the avatar by the user; and in response to authenticating use of the avatar by the user, present the avatar during the AR communication session.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file according to techniques of this disclosure.

FIG. 3 is a block diagram illustrating an example user equipment (UE) according to techniques of this disclosure.

FIG. 4 is a flowchart illustrating an example method of sending avatar data to a destination device according to techniques of this disclosure.

FIG. 5 is a flowchart illustrating an example method of authenticating avatar data received from a source device according to techniques of this disclosure.

### DETAILED DESCRIPTION

In general, this disclosure describes techniques for protecting content (e.g., images, virtual object data, audio data, or other content) exchanged during an augmented reality (AR) or other extended reality (XR) call, such as a mixed reality (MR) or virtual reality (VR) call.

GL Transmission Format 2.0 (glTF2) may be used as a scene description format to address needs of MPEG-I (Moving Pictures Experts Group-Immersive) and 6DoF (SixDegrees of Freedom) applications. Specifying extensions to glTF2 is described in, e.g., Khronos Group, The GL Transmission Format (gITF), version 2.0, github.com/KhronosGroup/glTF/tree/master/specification/2.0 #specifying-extensions.

In general, glTF2 may include data describing static or dynamic scenes. With respect to the techniques of this disclosure, glTF2 can be used to describe a scene including dynamic media data, such as audio, video, and XR/AR/MR/VR data. For example, a three-dimensional rendered scene may include an object, such as a display screen or other object, that presents video data. Likewise, the three-dimensional rendered scene may include an audio object positioned at a speaker in the three-dimensional rendered scene.

In an XR call, users may present themselves to others on the call using their own three-dimensional (3D) assets, such as 3D avatars, garments, AR affects, or the like. Immersive XR experiences may be based on shared virtual spaces, where people (represented by their avatars) join and interact with each other and the environment. Avatars may be a realistic representation of the user, or may be a “cartoonish” representation. Avatars may be animated to mimic the user's body pose and facial expressions. During an AR call or an AR experience in shared spaces, users may need to share their assets with other participants on the call. The AR call/experience may be described by a 3D scene that includes all participants. A gLTF 2.0 scene or scene update may represent the 3D scene. The assets (e.g., avatars) are represented as 3D objects, such as meshes and/or point clouds.

Participants in the AR call/experience may receive a 3D representation of other call members assets. That is, when in an immersive experience, each user shares their base model with the other users and then send animation streams to animate the base model. If unprotected, other users may make copies of these assets and use them after the AR call/experience for other purposes. In some cases, malicious users may even misuse the 3D assets to impersonate a participant in future AR calls/experiences or to otherwise misappropriate digital assets created by a user that may be protected as intellectual property, e.g., under copyright. That is, a user may impersonate another user by using their avatar in a communication session.

This disclosure describes techniques that may be used to restrict the usage of avatars to prevent digital asset theft, deep fakes, impersonation, and the like. In particular, devices involved in an XR communication session may periodically or continuously verify the identity of the avatar owner and match it to the avatar. In particular, the base avatar model may include encrypted data representing facial features of the base avatar model owner. This data may be encrypted using the public key of the certificate of the user. Alternatively, this data may be signed using the private key of the certificate of the user.

A telephony application may negotiate usage of an authentication scheme, which may include a sparse video stream that is captured from the user's device cameras. This video stream may be encrypted and run in a secure pipeline on the sender's device. The receiver may use the authentication video stream to extract facial features and compare the extracted facial features to those stored in the base avatar model. In this manner, the receiver may authenticate the user of the avatar.

In some examples, a user who owns an avatar may extract authentication features of themselves, such as facial features and/or vocal features, from image, video, and/or audio data. The user may then calculate a digital hash of the authentication features, then encrypt the hash using a private key of a public/private key pair associated with the user. In this manner, the user may digitally sign the authentication features. The user may then store the avatar and the digitally signed authentication features to a digital avatar repository (DAR) device or send the avatar and digitally signed authentication features directly to one or more other users involved in an augmented reality (AR) communication session with the user.

The other user(s) may thus receive the avatar and digitally signed authentication features either from the original user who owns the avatar or from the DAR device. The other users may also communicate with the user who owns the avatar using a voice or video call. During the voice/video call, the other users may extract authentication features from audio/video data of the call. The other users may also verify the digital signature of the stored authentication features of the user, e.g., by calculating a hash of the extracted authentication features and comparing the hash of the extracted authentication features to a decrypted version of the hash of the digitally signed authentication features. In particular, the other users may decrypt the hash of the digitally signed authentication features using a public key of the user. If the decrypted hash and the calculated hash match, the other users may determine that the avatar is authentically associated with the user. In some examples, authentication of the use of the avatar by the user may further include comparing distances between the extracted authentication features and the stored authentication features. Thus, user equipment (UE) devices of the other users may proceed to present the avatar to the other users during the AR communication session.

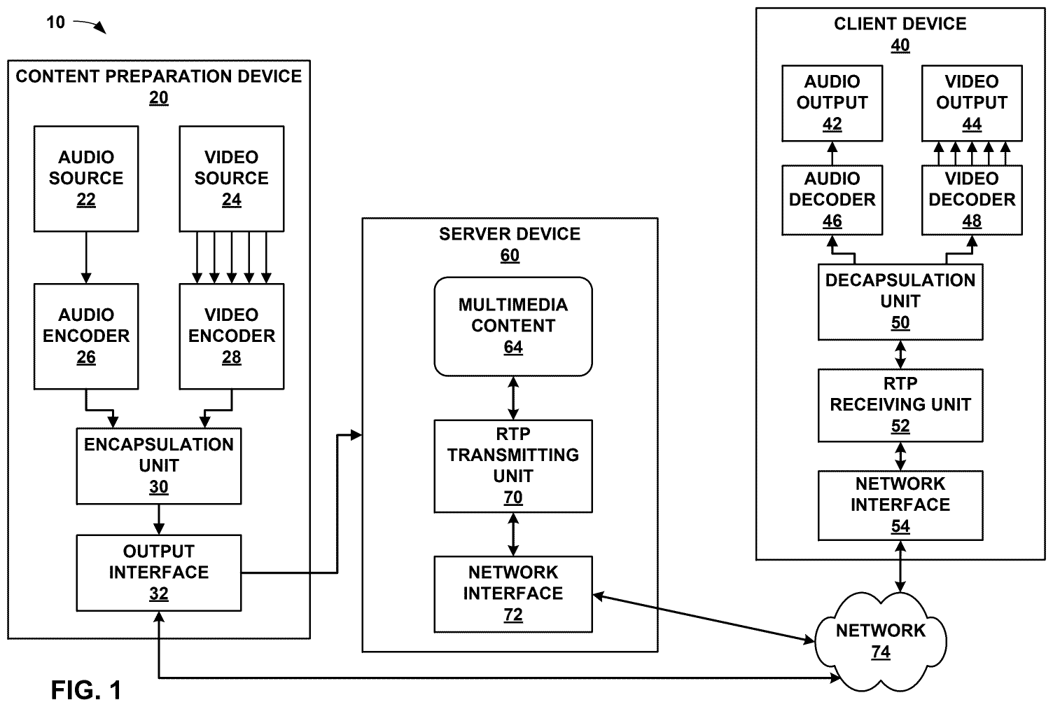

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Although referred to as “content preparation device 20” and “client device 40,” these devices may be understood as performing one part (direction) of a communication session. For example, content preparation device 20 may represent the sending-side elements of a communication session, while client device 40 may represent the receiving-side elements of the communication session. In practice, a general device (such as a user equipment (UE)) may include the elements of both content preparation device 20 and of client device 40. These devices may engage in a communication session, such as an extended reality (XR), augmented reality (AR), mixed reality (MR), or virtual reality (VR) communication session, including both sending and receiving data of such communication session.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL

NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Per techniques of this disclosure, client device 40 may send and/or receive avatar data for an AR communication session. For example, a user of client device 40 may have an avatar to be presented to represent the user during the AR communication session. To prevent unauthorized use of the avatar by other users, the user may perform the techniques of this disclosure. For example, the user may capture media data (e.g., audio, video, and/or image data) of distinguishing features of the user, such as the user's face, eyes, mouth, nose, head, jaw, or the like, and/or speech of particular key phrases using client device 40.

Client device 40 may then extract authentication features from the media data. Client device 40 may also calculate a hash of the authentication features. Client device 40 may then encrypt (digitally sign) the hash using a private key of the user of client device 40. Client device 40 may then distribute the avatar data, encrypted hash, and public key of the user, e.g., to other participants in the AR communication session.

In response to receiving an encrypted hash, public key, and avatar data of another participant, client device 40 may decrypt the hash using the received public key. Client device 40 may also engage in a voice, video, or other media communication session with the other participant. Client device 40 may extract authentication features from media data received during the voice/video/media communication session with the other participant. Client device 40 may then calculate a hash of the extracted authentication features. Client device 40 may then compare the decrypted hash to the calculated hash to determine whether the other participant is authorized to use the received avatar.

In this manner, client device 40 represents an example of a device for exchanging augmented reality (AR) media data, including: a memory configured to store AR media data; and a processing system comprising one or more processors implemented in circuitry and configured to: receive video data representing distinguishing elements of a user associated with an avatar to be presented during an AR communication session; extract authentication features from the video data; use a public key of the user to verify authenticity of stored authentication features corresponding to the avatar; in response to verifying authenticity of the stored authentication features, compare the extracted authentication features to stored authentication features to authenticate use of the avatar by the user; and in response to authenticating use of the avatar by the user, present the avatar during the AR communication session.

Likewise, client device 40 represents an example of a device for exchanging AR media data, including: a memory configured to store AR media data; and a processing system comprising one or more processors implemented in circuitry and configured to: encrypt authentication features representing distinguishing elements of a first user associated with an avatar to be presented during an AR communication session; send the encrypted authentication features and the avatar to a second user; and send one or more video streams of the distinguishing elements of the first user to the second user.

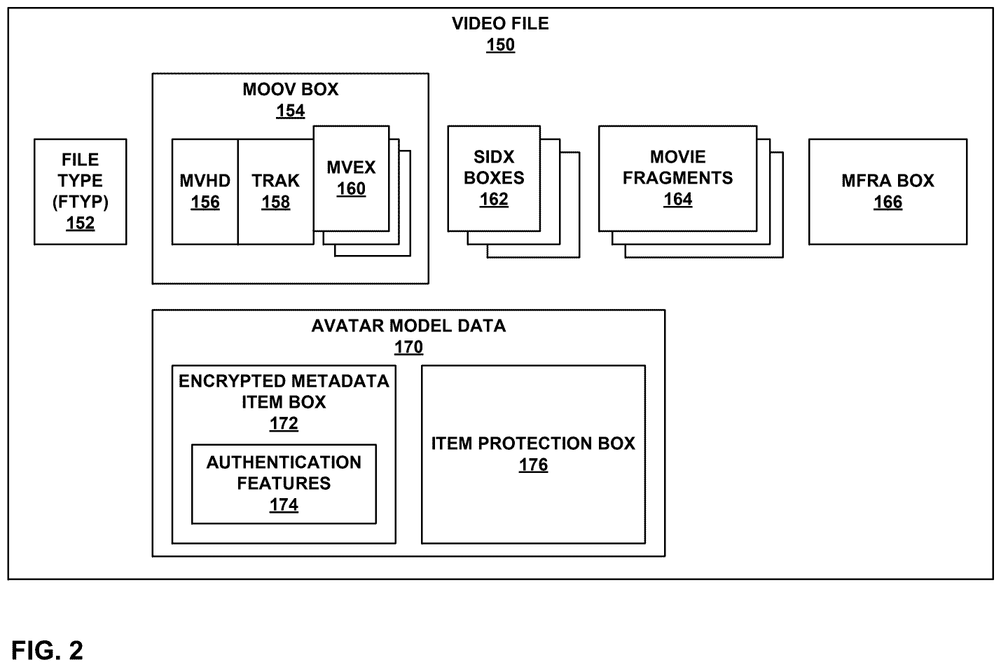

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

Per the techniques of this disclosure, in the example of FIG. 2, video file 150 (an example ISO Base Media File Format (ISO BMFF)) stores authentication features 174 as part of a base avatar model. That is, in this example, video file 150 includes avatar model data 170, which includes encrypted metadata item box 172 and item protection box 176. Authentication features 174 may be included in encrypted metadata item box 172, as in the example of FIG. 2. Encryption of authentication features 174 may be described in item protection box 176. The item may be identified through its content type in item protection box 176. For example, the content type for the item may be set to application/avatar features. In some examples, encrypted metadata item box 172 may store encrypted authentication features. In some examples, in addition or in the alternative, encrypted metadata item box may store an encrypted hash of the authentication features.

An avatar protection stream may be signaled in the same way for various protocols, such as Web Real-Time Communications (WebRTC) and IP Multimedia Subsystem (IMS). Session Description Protocol (SDP) may be used to signal data related to the avatar protection stream. For example, an encrypted video stream for a media line may be used, which may be signaled (e.g., using SDP) as:
m=video 19000 UDP/TLS/RTP/SAVP 100

An additional attribute may be used to signal that this stream is used for authentication purposes, such as:
a=auth-feature-stream: 100 type=facial composition=full

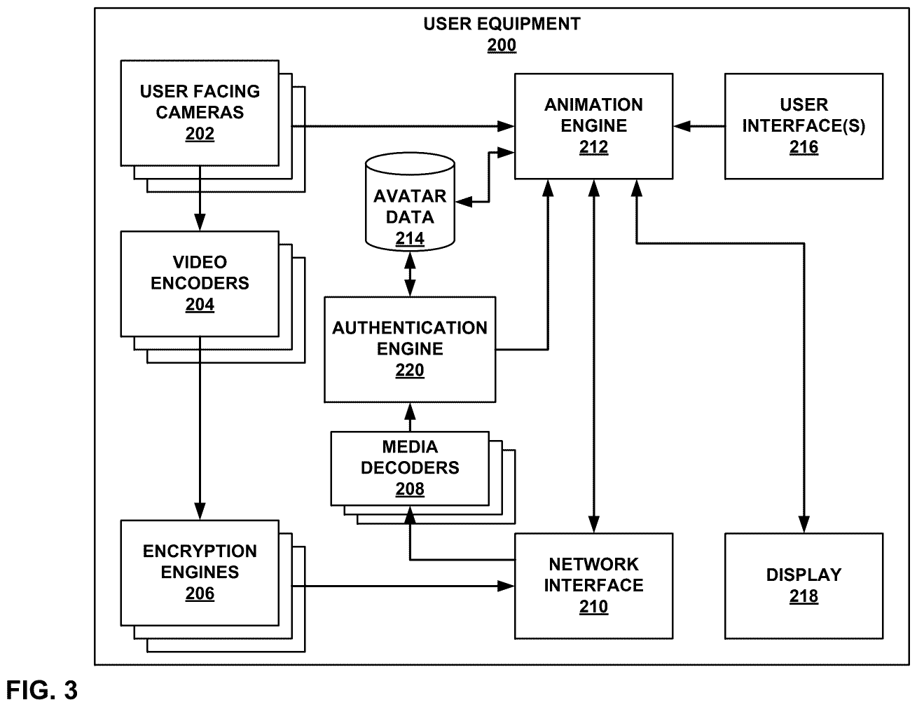

FIG. 3 is a block diagram illustrating an example user equipment (UE) 200. UE 200 may correspond to client device 40 of FIG. 1 or content preparation device 20 of FIG. 1. That is, content preparation device 20 of FIG. 1 may represent the elements used to prepare and send content as part of an XR communication session, while client device 40 may represent the elements used to receive and present such content to a user. However, in general, a participant device may both send and receive content during an XR communication session. In this example, UE 200 includes user facing cameras 202, video encoders 204, encryption engines 206, media decoders 208, network interface 210, authentication engine 220, avatar data 214, animation engine 212, user interface(s) 216, and display 218.

A user may use UE 200 to participate in an XR communication session, e.g., to both send and receive XR data with one or more other participants in the XR communication session. For example, UE 200 may receive inputs from the user via user interface(s) 216, which may correspond to buttons, controllers, track pads, joysticks, keyboards, sensors, or the like. Such inputs may represent, for example, movements of the user in real-world space to be translated into the virtual scene, such as locomotive movement, head movements, eye movements (captured by user facing cameras 202), or interactions with the various buttons or other interface devices.

Animation engine 212 may receive such inputs and determine how to animate a user's avatar, stored in avatar data 214. For example, such animations may include locomotive animations (walking or running), arm movement animations, hand movement animations, finger movement animations, and/or facial expression change animations. Animation engine 212 may provide animation information to network interface 210 for output to other participants in the XR communication session, along with other information such as, for example, interactions with virtual objects, movement direction, viewport, or the like.

In addition, per the techniques of this disclosure, user facing cameras 202 may provide one or more video streams of a user's face to video encoder(s) 204 to form an encoded video stream, which may be encrypted by encryption engine(s) 206 or sent unencrypted. That is, one or more video streams capturing distinguishing features of the user's face or other objects of interest (e.g., background objects, location-identifying objects, unique identifiers, or the like) may be sent via network interface 210 to one or more other participants in the XR communication session. When the user is wearing a head-mounted display (HMD), the HMD may be configured to capture only parts of the user's face by user-facing cameras 202 of the HMD (e.g., eyes and mouth may be captured as three distinct streams). Such video streams (which may further be encrypted) may be provided to network interface 210 and sent to other participants in the XR communication session, such that the UEs of the other participants can authenticate that the avatar data is actually coming from the user of UE 200, per the techniques of this disclosure. In general, the distinguishing features may be any one or more elements of a person, location, object, or the like that may be used to uniquely identify the target person, location, or object and to associate the avatar (or other 3D object) with the target person, location, or object.

Similarly, UE 200 may receive encrypted video stream(s) from the other participants in the XR communication session. UE 200 may decrypt and then decode the video stream(s) using media decoders 208, which may provide the decrypted video streams to authentication engine 220. Per the techniques of this disclosure, authentication engine 220 may compare data of the received video streams to authentication data associated with an avatar of the other user being authenticated, stored with avatar data 214.

As an example, authentication engine 220 may include a deep learning algorithm, e.g., an artificial intelligence/machine learning (AI/ML) model trained to extract facial features. The facial features may be a vector of values, e.g., 568 values, that provide a latent representation of a face. Distances to the facial features may be stored in the base avatar model as part of avatar data 214. That is, the facial features may be represented using a three-dimensional model, where the facial features may correspond to points in a three-dimensional space for the three-dimensional model. Thus, distances between the points may be used to determine authenticity of a user for which a new model has been generated. That is, distances between points of an existing three-dimensional model may be compared to corresponding distances between corresponding points of a newly generated three-dimensional model (that is, from features extracted from a video stream). Authentication engine 220 may calculate distances between facial features extracted from the received video bitstream(s) and compare these distances to the distances stored as part of avatar data 214, to determine if the user's face is the same as that of the user associated with the avatar. In addition to, or in the alternative to, facial features, other features may be used, such as 3D head features, vocal features, and/or light environments.

In this manner, UE 200 may perform techniques for verification and authentication of a user that is represented by an avatar, e.g., during an XR communication session. Likewise, UE 200 may both send and receive secure video streams that are low bitrate and used for feature extraction to be matched to stored and encrypted facial features.

For example, UE 200 may encrypt (digitally sign) extracted facial features from images of a user associated with UE 200 with a private key of a digital certificate associated with the user of UE 200, e.g., using video encoders 204 and encryption engines 206. Alternatively, UE 200 may encrypt the facial features using the public key of a user to which the encrypted facial features are to be sent. Likewise, UE 200 may receive encrypted video streams from other users and decrypt those video streams using public keys associated with those users or the private key of the user of UE 200. Assuming authentication engine 220 authenticates the other users based on these video streams, animation engine 212 may animate base avatar models stored in avatar data 214 associated with those users, based on movement data received from network interface 210, and present animated avatars to the user via display 218. Display 218 may represent a multi-eye display of an HMD that presents two slightly offset perspectives of the digital scene to provide a three-dimensional (3D) experience for the user.

In this manner, UE 200 represents an example of a device for exchanging augmented reality (AR) media data, including: a memory configured to store AR media data; and a processing system comprising one or more processors implemented in circuitry and configured to: receive video data representing distinguishing elements of a user associated with an avatar to be presented during an AR communication session; extract authentication features from the video data; use a public key of the user to verify authenticity of stored authentication features corresponding to the avatar; in response to verifying authenticity of the stored authentication features, compare the extracted authentication features to stored authentication features to authenticate use of the avatar by the user; and in response to authenticating use of the avatar by the user, present the avatar during the AR communication session.

Likewise, UE 200 represents an example of a device for exchanging AR media data, including: a memory configured to store AR media data; and a processing system comprising one or more processors implemented in circuitry and configured to: encrypt authentication features representing distinguishing elements of a first user associated with an avatar to be presented during an AR communication session; send the encrypted authentication features and the avatar to a second user; and send one or more video streams of the distinguishing elements of the first user to the second user.

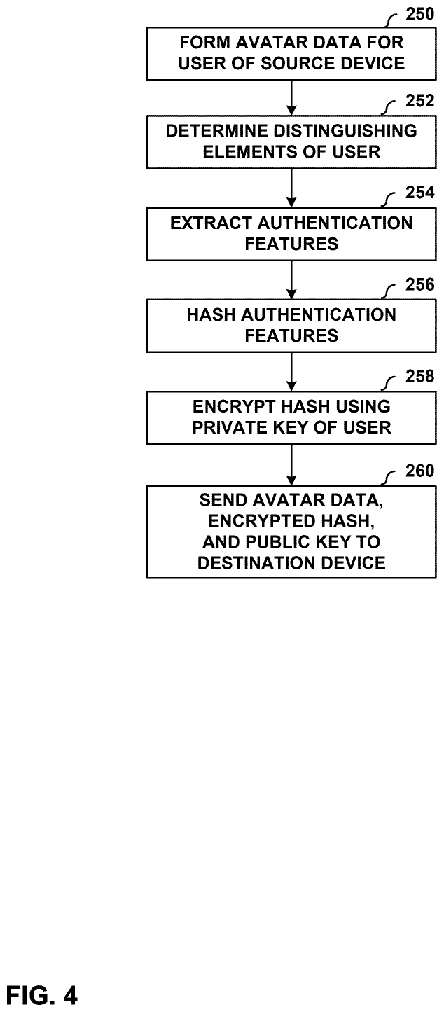

FIG. 4 is a flowchart illustrating an example method of sending avatar data to a destination device according to techniques of this disclosure. The method of FIG. 4 may be performed by a device (e.g., a UE device) of a user who wishes to send an avatar to one or more other participants in an AR communication session along with the user. The user may use the method of FIG. 4 to indicate that the user is authorized to use the avatar.

Initially, the user may form avatar data for the user of a source device, e.g., a source UE device (250). To form the avatar data, the user may construct the avatar, modify an existing avatar, generate an avatar, retrieve an avatar (new or existing), or the like.

The user may then cause the source device (e.g., their UE device, a desktop computing device, or the like) to determine distinguishing elements of the user (252). The distinguishing elements may include, for example, distinguishing audio and/or visual elements of the user. For example, the distinguishing elements may include one or more images of the user's head, face, nose, eyes, mouth, jaw, or the like. Additionally or alternatively, the distinguishing elements may include vocal features, such as the pronunciation of certain key words or phrases, environmental features such as light environment features, or the like. To determine the distinguishing elements, the user may use the UE device to capture audio, video, and/or image data of the user. For example, the user may capture a video directed at the user's face while the user speaks a particular key phrase. The UE device may then extract authentication features from the audio, image, and/or video data (254).

The UE device may then hash the authentication features or data representative of the authentication features (256). The user may have a public key/private key pair, e.g., of a public key infrastructure. Thus, the UE device may encrypt the hash of the authentication features using the private key (258). In this manner, the public key of the public/private key pair may be used to decrypt the encrypted hash of the authentication features. Because it can be assumed that only the user associated with the avatar has access to the private key, and because only data encrypted using the private key can be successfully decrypted using the corresponding public key, it can be safely determined that only the user associated with the avatar could have encrypted the hash of the authentication features. Accordingly, the UE device may send the avatar data, the encrypted hash, and the public key to one or more destination devices, e.g., other UE devices involved in the AR communication session which the user would like to grant access to the avatar.

In this manner, the method of FIG. 4 represents an example of a method of sending augmented reality (AR) media data, including: encrypting authentication features representing distinguishing elements of a first user associated with an avatar to be presented during an AR communication session; sending the encrypted authentication features and the avatar to a second user; and sending one or more video streams of the distinguishing elements of the first user to the second user.

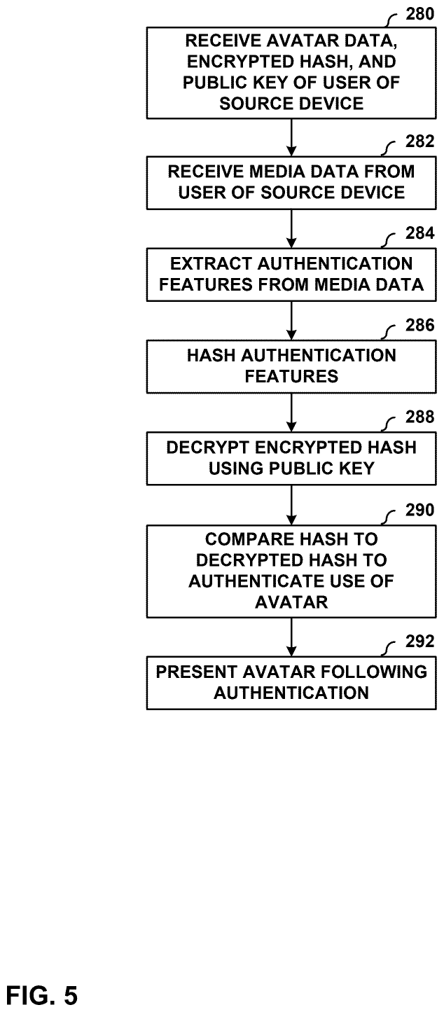

FIG. 5 is a flowchart illustrating an example method of authenticating avatar data received from a source device according to techniques of this disclosure. The method of FIG. 5 may be performed by a UE device participating in an AR communication session. For example, the method of FIG. 5 may be performed by a receiving UE device to which the avatar data, encrypted hash, and public key were sent by another UE device per the method of FIG. 4. In general, a UE device may perform both the method of FIG. 4 (to send avatar data to other UE devices involved in an AR communication session) and the method of FIG. 5 (to receive avatar data from other UE devices involved in the AR communication session).

Initially, the UE device may receive avatar data, an encrypted hash of authentication features, and a public key of a user of a source device (280) involved in an AR communication session. The UE device may also receive media data from the user of the source device (282). For example, the user of the UE device and the user of the source device may initially participate in a voice or video call, during which the UE device may receive media data, such as audio, image, and/or video data of the user of the source device.

The UE device may then extract authentication features from the media data (284) and hash the extracted authentication features (286). The UE device may also decrypt the encrypted hash of received authentication features using the public key of the user of the source device (288). The UE device may then compare the hash of the extracted authentication features with the decrypted hash to authenticate the use of the avatar by the user (290). That is, assuming the calculated hash of the extracted authentication features matches the decrypted hash, then the UE device may determine that the user is permitted to use the avatar. Therefore, the UE device may present the avatar following authentication during the AR communication session (292). If the decrypted hash does not match the hash of the extracted authentication features, the UE device may avoid presenting the avatar, present a distorted avatar, present data indicating that the user is not authorized to use the avatar, or otherwise avoid presenting the avatar as if the user were authorized to use the avatar.

In this manner, the method of FIG. 5 represents an example of a method of receiving augmented reality (AR) media data, including: receiving video data representing distinguishing elements of a user associated with an avatar to be presented during an AR communication session; extracting authentication features from the video data; using a public key of the user to verify authenticity of stored authentication features corresponding to the avatar; in response to verifying authenticity of the stored authentication features, comparing the extracted authentication features to stored authentication features to authenticate use of the avatar by the user; and in response to authenticating use of the avatar by the user, presenting the avatar during the AR communication session.

Various examples of the techniques of this disclosure are summarized in the clauses below:

Clause 1: A method of receiving extended reality (XR) media data, the method comprising: receiving video data representing distinguishing elements of a user associated with an avatar to be presented during an XR communication session; extracting authentication features from the video data; comparing the extracted authentication features to stored authentication features to authenticate the user; and in response to authenticating the user, presenting the avatar during the XR communication session.

Clause 2: The method of clause 1, wherein the distinguishing elements of the user include one or more of eyes, a mouth, or a face of the user, and wherein extracting the authentication features comprises extracting features representative of the eyes, mouth, or face of the user from the video data.

Clause 3: The method of clause 2, further comprising receiving data representing additional distinguishing features of the user, the additional distinguishing features including one or more of three-dimensional head features, vocal features, or light environment features.

Clause 4: The method of any of clauses 1-3, wherein extracting the authentication features comprises applying an artificial intelligence/machine learning (AI/ML) model to the video data to extract the authentication features.

Clause 5: The method of any of clauses 1-4, wherein comparing comprises calculating distances between the extracted authentication features and comparing the calculated distances to pre-determined distances from the stored authentication features.

Clause 6: The method of any of clauses 1-5, further comprising receiving an ISO base media file format (ISO BMFF)-formatted file including the stored authentication features.

Clause 7: The method of clause 6, wherein the stored authentication features are included in an encrypted metadata item box of the ISO BMFF-formatted file.

Clause 8: The method of any of clauses 6 and 7, wherein the ISO BMFF-formatted file further includes an item protection box indicating that the ISO BMFF-formatted file includes the stored authentication features.

Clause 9: The method of any of clauses 1-8, further comprising receiving animation data for the avatar, wherein presenting the avatar comprises animating the avatar according to the animation data.

Clause 10: The method of clause 1, wherein the distinguishing elements of the user include one or more of eyes, a mouth, or a face of the user, and wherein extracting the authentication features comprises extracting features representative of the eyes, mouth, or face of the user from the video data.

Clause 11: The method of clause 10, further comprising receiving data representing additional distinguishing features of the user, the additional distinguishing features including one or more of three-dimensional head features, vocal features, or light environment features.

Clause 12: The method of clause 1, wherein extracting the authentication features comprises applying an artificial intelligence/machine learning (AI/ML) model to the video data to extract the authentication features.

Clause 13: The method of clause 1, wherein comparing comprises calculating distances between the extracted authentication features and comparing the calculated distances to pre-determined distances from the stored authentication features.

Clause 14: The method of clause 1, further comprising receiving an ISO base media file format (ISO BMFF)-formatted file including the stored authentication features.

Clause 15: The method of clause 14, wherein the stored authentication features are included in an encrypted metadata item box of the ISO BMFF-formatted file.

Clause 16: The method of clause 14, wherein the ISO BMFF-formatted file further includes an item protection box indicating that the ISO BMFF-formatted file includes the stored authentication features.

Clause 17: The method of clause 1, further comprising receiving animation data for the avatar, wherein presenting the avatar comprises animating the avatar according to the animation data.

Clause 18: A method of sending extended reality (XR) media data, the method comprising: encrypting authentication features representing distinguishing elements of a first user associated with an avatar to be presented during an XR communication session; sending the encrypted authentication features and the avatar to a second user; and sending one or more video streams of the distinguishing elements of the first user to the second user.

Clause 19: A method comprising a combination of the method of clause 18 and the method of any of clauses 1-17.

Clause 20: The method of any of clauses 18 and 19, wherein the distinguishing elements of the user include one or more of eyes, a mouth, or a face of the first user, and wherein the authentication features comprise features extracted from video data corresponding to the eyes, mouth, or face of the first user.

Clause 21: The method of clause 20, further comprising sending data representing additional distinguishing features of the first user, the additional distinguishing features including one or more of three-dimensional head features, vocal features, or light environment features.

Clause 22: The method of any of clauses 18-21, wherein sending the encrypted authentication features and the avatar comprises sending the encrypted authentication features and the avatar in an ISO base media file format (ISO BMFF)-formatted file.

Clause 23: The method of clause 22, wherein the encrypted authentication features are included in an encrypted metadata item box of the ISO BMFF-formatted file.

Clause 24: The method of any of clauses 22 and 23, wherein the ISO BMFF-formatted file further includes an item protection box indicating that the ISO BMFF-formatted file includes the stored authentication features.

Clause 25: The method of any of clauses 18-24, further comprising: receiving one or more inputs from the first user representing movements of the first user; determining animation data corresponding to the movements of the first user; and sending the animation data to the second user.

Clause 26: The method of clause 18, wherein the distinguishing elements of the user include one or more of eyes, a mouth, or a face of the first user, and wherein the authentication features comprise features extracted from video data corresponding to the eyes, mouth, or face of the first user.

Clause 27: The method of clause 26, further comprising sending data representing additional distinguishing features of the first user, the additional distinguishing features including one or more of three-dimensional head features, vocal features, or light environment features.

Clause 28: The method of clause 18, wherein sending the encrypted authentication features and the avatar comprises sending the encrypted authentication features and the avatar in an ISO base media file format (ISO BMFF)-formatted file.

Clause 29: The method of clause 28, wherein the encrypted authentication features are included in an encrypted metadata item box of the ISO BMFF-formatted file.

Clause 30: The method of clause 28, wherein the ISO BMFF-formatted file further includes an item protection box indicating that the ISO BMFF-formatted file includes the stored authentication features.

Clause 31: The method of clause 18, further comprising: receiving one or more inputs from the first user representing movements of the first user; determining animation data corresponding to the movements of the first user; and sending the animation data to the second user.

Clause 32: A device for exchanging extended reality (XR) media data, the device comprising one or more means for performing the method of any of clauses 1-31.

Clause 33: The device of clause 32, wherein the one or more means comprise: a memory configured to store XR media data; and a processing system comprising one or more processors implemented in circuitry.

Clause 34: The device of clause 32, wherein the apparatus comprises at least one of: an integrated circuit; a microprocessor; or a wireless communication device.

Clause 35: A device for receiving extended reality (XR) media data, the device comprising: means for receiving video data representing distinguishing elements of a user associated with an avatar to be presented during an XR communication session; means for extracting authentication features from the video data; means for comparing the extracted authentication features to stored authentication features to authenticate the user; and means for presenting, in response to authenticating the user, the avatar during the XR communication session.

Clause 36: A device for sending extended reality (XR) media data, the device comprising: means for encrypting authentication features representing distinguishing elements of a first user associated with an avatar to be presented during an XR communication session; means for sending the encrypted authentication features and the avatar to a second user; and means for sending one or more video streams of the distinguishing elements of the first user to the second user.

Clause 37: A computer-readable storage medium having stored thereon instructions that, when executed, cause a processor to perform the method of any of clauses 1-31.

Clause 38: A method of receiving augmented reality (AR) media data, the method comprising: receiving video data representing distinguishing elements of a user associated with an avatar to be presented during an AR communication session; extracting authentication features from the video data; using a public key of the user to verify authenticity of stored authentication features corresponding to the avatar; in response to verifying authenticity of the stored authentication features, comparing the extracted authentication features to stored authentication features to authenticate use of the avatar by the user; and in response to authenticating use of the avatar by the user, presenting the avatar during the AR communication session.

Clause 39: The method of clause 38, wherein using the public key to of the user to verify the authenticity of the stored authentication features comprises decrypting data corresponding to the stored authentication features using the public key of the user.

Clause 40: The method of any of clauses 38 and 39, wherein the distinguishing elements of the user include one or more of eyes, a mouth, or a face of the user, and wherein extracting the authentication features comprises extracting features representative of the eyes, the mouth, or the face of the user from the video data.

Clause 41: The method of clause 40, further comprising receiving data representing additional distinguishing features of the user, the additional distinguishing features including one or more of three-dimensional head features, vocal features, or light environment features.

Clause 42: The method of any of clauses 38-41, wherein extracting the authentication features comprises applying an artificial intelligence/machine learning (AI/ML) model to the video data to extract the authentication features.

Clause 43: The method of any of clauses 38-42, wherein comparing comprises calculating distances between the extracted authentication features and comparing the calculated distances to pre-determined distances from the stored authentication features.

Clause 44: The method of any of clauses 38-43, further comprising receiving an ISO base media file format (ISO BMFF)-formatted file including the stored authentication features.

Clause 45: The method of clause 44, wherein the stored authentication features are included in an encrypted metadata item box of the ISO BMFF-formatted file.

Clause 46: The method of any of clauses 44 and 45, wherein the ISO BMFF-formatted file further includes an item protection box indicating that the ISO BMFF-formatted file includes the stored authentication features.

Clause 47: The method of any of clauses 38-46, further comprising receiving animation data for the avatar, wherein presenting the avatar comprises animating the avatar according to the animation data.

Clause 48: A method of sending augmented reality (AR) media data, the method comprising: encrypting authentication features representing distinguishing elements of a first user associated with an avatar to be presented during an AR communication session; sending the encrypted authentication features and the avatar to a second user; and sending one or more video streams of the distinguishing elements of the first user to the second user.

Clause 49: The method of clause 48, wherein the distinguishing elements of the user include one or more of eyes, a mouth, or a face of the first user, and wherein the authentication features comprise features extracted from video data corresponding to the eyes, mouth, or face of the first user.

Clause 50: The method of clause 49, further comprising sending data representing additional distinguishing features of the first user, the additional distinguishing features including one or more of three-dimensional head features, vocal features, or light environment features.

Clause 51: The method of any of clauses 48-50, wherein sending the encrypted authentication features and the avatar comprises sending the encrypted authentication features and the avatar in an ISO base media file format (ISO BMFF)-formatted file.

Clause 52: The method of clause 51, wherein the encrypted authentication features are included in an encrypted metadata item box of the ISO BMFF-formatted file.

Clause 53: The method of any of clauses 51 and 52, wherein the ISO BMFF-formatted file further includes an item protection box indicating that the ISO BMFF-formatted file includes the stored authentication features.

Clause 54: The method of any of clauses 48-53, further comprising: receiving one or more inputs from the first user representing movements of the first user; determining animation data corresponding to the movements of the first user; and sending the animation data to the second user.

Clause 55: A device for exchanging augmented reality (AR) media data, the device comprising: a memory configured to store AR media data; and a processing system comprising one or more processors implemented in circuitry and configured to: receive video data representing distinguishing elements of a user associated with an avatar to be presented during an AR communication session; extract authentication features from the video data; use a public key of the user to verify authenticity of stored authentication features corresponding to the avatar; in response to verifying authenticity of the stored authentication features, compare the extracted authentication features to stored authentication features to authenticate use of the avatar by the user; and in response to authenticating use of the avatar by the user, present the avatar during the AR communication session.

Clause 56: The device of clause 55, wherein the avatar comprises a first avatar, the user comprises a first user, the distinguishing elements comprise first distinguishing elements, and the authentication features comprise first authentication features, and wherein the processing system is further configured to: encrypt second authentication features representing second distinguishing elements of a second user associated with a second avatar to be presented during the AR communication session to form second encrypted authentication features, the second user being a user of the device; send the second encrypted authentication features and the second avatar to the first user; and send one or more video streams of the second distinguishing elements of the second user to the first user.

Clause 57: The device of any of clauses 55 and 56, wherein to use the public key to of the user to verify the authenticity of the stored authentication features, the processing system is configured to decrypt data corresponding to the stored authentication features using the public key of the user.

Clause 58: A method of receiving augmented reality (AR) media data, the method comprising: receiving media data representing distinguishing elements of a user associated with an avatar to be presented during an AR communication session; extracting authentication features representing the distinguishing elements of the user from the media data to produce extracted authentication features; comparing the extracted authentication features to stored authentication features to authenticate use of the avatar by the user; and in response to authenticating use of the avatar by the user, presenting the avatar during the AR communication session.

Clause 59: The method of clause 58, further comprising using a public key of the user to verify authenticity of stored authentication features corresponding to the avatar, wherein comparing the extracted authentication features comprises, in response to verifying authenticity of the stored authentication features, comparing the extracted authentication features to the stored authentication features.

Clause 60: The method of clause 59, wherein using the public key of the user to verify the authenticity of the stored authentication features comprises decrypting data corresponding to the stored authentication features using the public key of the user.

Clause 61: The method of clause 58, wherein the distinguishing elements of the user include one or more of eyes, a mouth, or a face of the user, and wherein extracting the authentication features comprises extracting features representative of the one or more of the eyes, the mouth, or the face of the user from the media data.

Clause 62: The method of clause 61, further comprising receiving data representing additional distinguishing elements of the user, the additional distinguishing elements including one or more of three-dimensional head features, vocal features, or light environment features.

Clause 63: The method of clause 58, wherein the extracted authentication features are represented by a three-dimensional model having points at three-dimensional coordinates corresponding to the extracted authentication features, and wherein comparing comprises calculating distances between the points corresponding to the extracted authentication features and comparing the calculated distances to pre-determined distances from the stored authentication features.

Clause 64: The method of clause 58, further comprising receiving an ISO base media file format (ISO BMFF)-formatted file including the stored authentication features.

Clause 65: The method of clause 64, wherein the stored authentication features are included in an encrypted metadata item box of the ISO BMFF-formatted file.

Clause 66: The method of clause 64, wherein the ISO BMFF-formatted file further includes an item protection box indicating that the ISO BMFF-formatted file includes the stored authentication features.

Clause 67: The method of clause 58, further comprising receiving animation data for the avatar, wherein presenting the avatar comprises animating the avatar according to the animation data.

Clause 68: A method of sending augmented reality (AR) media data, the method comprising: encrypting data representing authentication features corresponding to distinguishing elements of a first user associated with an avatar to be presented during an AR communication session; sending the encrypted data and the avatar to a second user; and sending media streams of the distinguishing elements of the first user to the second user.

Clause 69: The method of clause 68, wherein the distinguishing elements of the user include one or more of eyes, a mouth, or a face of the first user, and wherein the authentication features comprise features extracted from media data corresponding to the one or more of the eyes, mouth, or face of the first user.

Clause 70: The method of clause 69, further comprising sending data representing additional distinguishing elements of the first user, the additional distinguishing elements including one or more of three-dimensional head features, vocal features, or light environment features.

Clause 71: The method of clause 68, wherein sending the encrypted data and the avatar comprises sending the encrypted authentication features and the avatar in an ISO base media file format (ISO BMFF)-formatted file.

Clause 72: The method of clause 71, wherein the encrypted data is included in an encrypted metadata item box of the ISO BMFF-formatted file.

Clause 73: The method of clause 71, wherein the ISO BMFF-formatted file further includes an item protection box indicating that the ISO BMFF-formatted file includes the encrypted data.

Clause 74: The method of clause 68, further comprising: receiving one or more inputs from the first user representing movements of the first user; determining animation data corresponding to the movements of the first user; and sending the animation data to the second user.

Clause 75: A device for exchanging augmented reality (AR) media data, the device comprising: a memory configured to store AR media data; and a processing system comprising one or more processors implemented in circuitry and configured to: receive media data representing distinguishing elements of a user associated with an avatar to be presented during an AR communication session; extract authentication features representing the distinguishing elements of the user from the media data to produce extracted authentication features; compare the extracted authentication features to stored authentication features to authenticate use of the avatar by the user; and in response to authenticating use of the avatar by the user, present the avatar during the AR communication session.

Clause 76: The device of clause 75, wherein the avatar comprises a first avatar, the user comprises a first user, the distinguishing elements comprise first distinguishing elements, and the authentication features comprise first authentication features, and wherein the processing system is further configured to: encrypt second data representing authentication features corresponding to second distinguishing elements of a second user associated with a second avatar to be presented during the AR communication session to form second encrypted authentication features, the second user being a user of the device; send the second encrypted data and the second avatar to the first user; and send media streams of the second distinguishing elements of the second user to the first user.

Clause 77: The device of clause 75, wherein the processing system is further configured to use a public key of the user to verify authenticity of the stored authentication features corresponding to the avatar, and in response to verifying authenticity of the stored authentication features, compare the extracted authentication features to the stored authentication features, wherein to use the public key to of the user to verify the authenticity of the stored authentication features, the processing system is configured to decrypt data corresponding to the stored authentication features using the public key of the user.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving augmented reality (AR) media data, the method comprising:
receiving media data representing distinguishing elements of a user associated with an avatar to be presented during an AR communication session;
extracting authentication features representing the distinguishing elements of the user from the media data to produce extracted authentication features;
comparing the extracted authentication features to stored authentication features to authenticate use of the avatar by the user; and
in response to authenticating use of the avatar by the user, presenting the avatar during the AR communication session.

2. The method of claim 1, further comprising using a public key of the user to verify authenticity of stored authentication features corresponding to the avatar, wherein comparing the extracted authentication features comprises, in response to verifying authenticity of the stored authentication features, comparing the extracted authentication features to the stored authentication features.

3. The method of claim 2, wherein using the public key of the user to verify the authenticity of the stored authentication features comprises decrypting data corresponding to the stored authentication features using the public key of the user.

4. The method of claim 1, wherein the distinguishing elements of the user include one or more of eyes, a mouth, or a face of the user, and wherein extracting the authentication features comprises extracting features representative of the one or more of the eyes, the mouth, or the face of the user from the media data.

5. The method of claim 4, further comprising receiving data representing additional distinguishing elements of the user, the additional distinguishing elements including one or more of three-dimensional head features, vocal features, or light environment features.

6. The method of claim 1, wherein the extracted authentication features are represented by a three-dimensional model having points at three-dimensional coordinates corresponding to the extracted authentication features, and wherein comparing comprises calculating distances between the points corresponding to the extracted authentication features and comparing the calculated distances to pre-determined distances from the stored authentication features.

7. The method of claim 1, further comprising receiving an ISO base media file format (ISO BMFF)-formatted file including the stored authentication features.

8. The method of claim 7, wherein the stored authentication features are included in an encrypted metadata item box of the ISO BMFF-formatted file.

9. The method of claim 7, wherein the ISO BMFF-formatted file further includes an item protection box indicating that the ISO BMFF-formatted file includes the stored authentication features.

10. The method of claim 1, further comprising receiving animation data for the avatar, wherein presenting the avatar comprises animating the avatar according to the animation data.

11. A method of sending augmented reality (AR) media data, the method comprising:
encrypting data representing authentication features corresponding to distinguishing elements of a first user associated with an avatar to be presented during an AR communication session;
sending the encrypted data and the avatar to a second user; and
sending media streams of the distinguishing elements of the first user to the second user.

12. The method of claim 11, wherein the distinguishing elements of the user include one or more of eyes, a mouth, or a face of the first user, and wherein the authentication features comprise features extracted from media data corresponding to the one or more of the eyes, mouth, or face of the first user.

13. The method of claim 12, further comprising sending data representing additional distinguishing elements of the first user, the additional distinguishing elements including one or more of three-dimensional head features, vocal features, or light environment features.

14. The method of claim 11, wherein sending the encrypted data and the avatar comprises sending the encrypted authentication features and the avatar in an ISO base media file format (ISO BMFF)-formatted file.

15. The method of claim 14, wherein the encrypted data is included in an encrypted metadata item box of the ISO BMFF-formatted file.

16. The method of claim 14, wherein the ISO BMFF-formatted file further includes an item protection box indicating that the ISO BMFF-formatted file includes the encrypted data.

17. The method of claim 11, further comprising:
receiving one or more inputs from the first user representing movements of the first user;
determining animation data corresponding to the movements of the first user; and
sending the animation data to the second user.

18. A device for exchanging augmented reality (AR) media data, the device comprising:
a memory configured to store AR media data; and
a processing system comprising one or more processors implemented in circuitry and configured to:
receive media data representing distinguishing elements of a user associated with an avatar to be presented during an AR communication session;
extract authentication features representing the distinguishing elements of the user from the media data to produce extracted authentication features;
compare the extracted authentication features to stored authentication features to authenticate use of the avatar by the user; and
in response to authenticating use of the avatar by the user, present the avatar during the AR communication session.

19. The device of claim 18, wherein the avatar comprises a first avatar, the user comprises a first user, the distinguishing elements comprise first distinguishing elements, and the authentication features comprise first authentication features, and wherein the processing system is further configured to:
encrypt second data representing authentication features corresponding to second distinguishing elements of a second user associated with a second avatar to be presented during the AR communication session to form second encrypted authentication features, the second user being a user of the device;
send the second encrypted data and the second avatar to the first user; and
send media streams of the second distinguishing elements of the second user to the first user.

20. The device of claim 18, wherein the processing system is further configured to use a public key of the user to verify authenticity of the stored authentication features corresponding to the avatar, and in response to verifying authenticity of the stored authentication features, compare the extracted authentication features to the stored authentication features, wherein to use the public key to of the user to verify the authenticity of the stored authentication features, the processing system is configured to decrypt data corresponding to the stored authentication features using the public key of the user.
